(19) United States
(12) Patent Application Publication
(10) Pub. No.: US 2016/0162136 A1
(43) Pub. Date: Jun. 9, 2016

(54) METHOD AND SYSTEM FOR E-BOOK READING-LAUNCH INTERFACE

(71) Applicant: Kobo Incorporated, Toronto (CA)

(72) Inventor: Inae HEO, North York (CA)

(73) Assignee: KOBO INCORPORATED, Toronto (CA)

(21) Appl. No.: 14/560,882

(22) Filed: Dec. 4, 2014

(51) Int. Cl. G06F 3/0483; G06F 3/0481; G06F 17/24

(52) U.S. Cl. CPC G06F 3/0483; G06F 17/241; G06F 3/04817

(57) ABSTRACT

A method and system for presenting an e-book reading interface for a subsequent reading, as an alternative to a fixedly-configured table of contents pages typical of physical paper books. The method includes receiving annotation entries at respective content portions of an e-book having text content presented in an ordered sequence; generating an annotations interface page including indicia for the annotation entries, the indicia presented in the pre-ordered sequence of the content portions; receiving a further annotation entry at a further content portion of the e-book; arranging an indicium of the further annotation entry within the respective indicia of the annotation entries of the annotations interface page consistent with an order of the further content portion within the respective content portions; and upon receiving a start-reading input action enacted upon a graphical icon representing the e-book, launching the annotations interface page for display.

### TECHNICAL FIELD

Examples described herein relate to a system and method for operating a computing device in providing a e-library view logic interface for digital reading (e-reading).

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-readers) such (e.g., Apple iPad®, Microsoft® Surfacer™, Samsung Galaxy Tab® and the like), handheld multimedia smartphones Apple iPhone®, Samsung Galaxy S®, and the like), and handheld electronic readers (e.g., Amazon Kindle®, Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete payees of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the receive the full benefit and functionality of the device.

Yet further, such devices may incorporate a touch screen display having integrated touch sensors and touch sensing functionality, whereby user input commands via touch-based gestures are received thereon.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device configured for operation of an e-book reading launch interface, in an embodiment.

FIG. 2 illustrates a schematic architecture of a computing device for configuring and launching an e-book reading interface, according to an embodiment.

FIGS. 3a and 3b illustrate example embodiments for operation in configuring and launching an e-book reading interface.

FIG. 4 illustrates a method for operation in for configuring and launching an e-book reading interface on a computer device having a touchscreen display, according to an embodiment.

### DETAILED DESCRIPTION

“E-books” are a form of electronic publication content stored in digital format in a computer non-transitory memory, viewable on a computing device having display functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein.

An “e-reading device”, variously referred to herein as an electronic personal display or mobile computing device, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with E-ink displays).

While conventional physical paper books typically include a fixedly-configured table of contents page(s) intended to assist a user or observer to locate a desired portion or page of the book for reading, a digitally rendered e-book may be configured in other, more fluid arrangements that allow alternative ways for a user to conveniently access a particular content portion or page of the e-book.

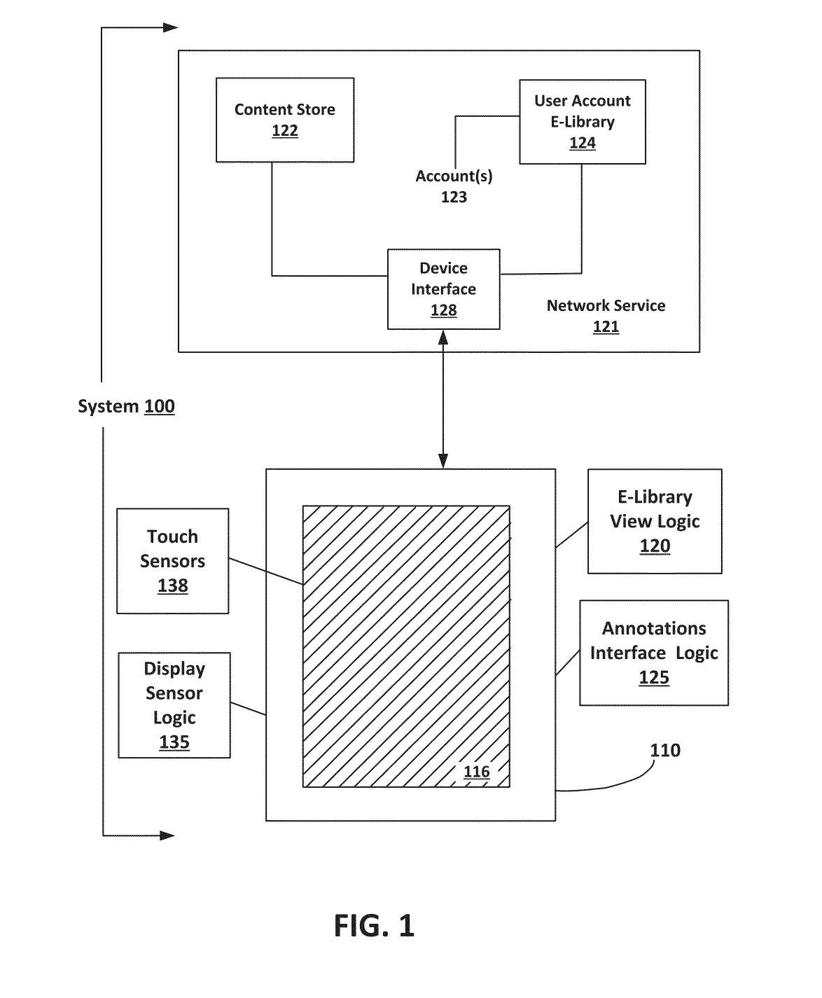

FIG. 1 illustrates a system 100 for utilizing applications and providing e-book services on a computing device configured for operation of an e-book reading launch interface, according to an embodiment. In an example of FIG. 1, system 100 includes an electronic personal display device, shown by way of example as an e-reading device 110, and a network service 121. The network service 121 can include multiple servers and other computing resources that provide various services in connection with one or more applications that are installed on the e-reading device 110. By way of example, in one implementation, the network service 121 can provide e-book services that communicate with the e-reading device 110. The e-book services provided through network service 121 can, for example, include services in which e-books are sold, shared, downloaded and/or stored. More generally, the network service 121 can provide various other content services, including content rendering services (e.g., streaming media) or other network application environments or services.

The e-reading device 110 can correspond to any electronic personal display device on which applications and application resources (e.g., e-books, media files, documents) can be rendered and consumed. For example, the e-reading device 110 can correspond to a tablet or a. telephony/messaging device (e.g., smart phone). In one implementation, for example, e-reading device 110 can run an e-reader application that links the device to the network service 121 and enables e-books provided through the service to be viewed and consumed by way of e-reading. In another implementation, the e-reading device 110 can run a media playback or streaming application that receives files or streaming data from the network service 121. By way of example, thee-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 121 can include a device interface 128, a content store 122 and a user account electronic library (e-library) 124 storing e-books or digital content items. Content store 122 may be an online store for purchasing of digital content items for download therefrom onto a resident memory of e-reading device 110 and/or user account e-library 124. User account e-library 124 associates the e-reading device 110 with a user having an account 123. The account 123 can also be associated with ownership of, and/or accessibility to, one or more digital content items stored in content store 122. In one embodiment, the digital content items are e-books, and the content store 122 is an online store having e-books for purchase or other licensed use. The device interface 128 can handle requests from the e-reading device 110 with regard to services and functionality of the network service 121. The device interface 128 can utilize information provided with user account 123 in order to enable services, such as purchasing and downloading of e-books into user account e-library 124, and determining what e-books and content items providable via content store 122 are associated with, and accessible to, user account 123. Additionally, the device interface 128 can provide the e-reading device 110 with access to the on-line content store 122. The device interface 128 can handle input to identify content items (e.g., e-books), and further to link content items to the account 123 of the user.

Yet further, the user account e-library 124 can retain metadata for individual accounts 123 to identify e-books or other digital content items that have been purchased or made available for consumption for a given account. Thus information relating to e-books within user account e-library 124 can include a metadata set in addition to substantive digital text and image content portions. The metadata set can include, for example, information such as the graphic representation of the e-book, such as including artwork- or image-based representation of a counterpart physical paper book cover, as well as summary information, author information, title, short synapse or book review, publication date and language of the e-book, and book or volume series information.

The e-reading device 110 may be associated with the user account 123, and multiple devices may be associated with the same account. As described in greater detail below, e-reading device 110 can locally store content items (e.g., e-books) that are purchased or otherwise made available to the user of the e-reading device 110 as well as to archive, in user account 124, e-books and other digital content items that have been purchased for the user account 123, but are not necessarily stored in local resident memory of computing device 110.

With reference to an example of FIG. 1, e-reading device 110 can include a touchscreen display 116. In an embodiment, the display screen 116 is touch-sensitive, to process touch inputs including gestures (e.g., swipes). For example, the display screen 116 may be integrated with one or more touch sensors 1138 to provide a touch-sensing region on a surface of the display screen 116. For some embodiments, the one or more touch sensors 138 may include capacitive sensors that can sense or detect a human body's capacitance as input. In the example of FIG. 1, the touch-sensing region coincides with a substantial surface area, if not all, of the display screen 116.

In some embodiments, the e-reading device 110 includes features for providing functionality related to displaying paginated content, including paginated content comprising an e-magazine or e-comic book. The e-reading device 110 can include page transitioning logic, which enables the user to transition through paginated content. The e-reading device 110 can display pages of e-books, e-magazines and e-comics, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic can operate to enable the user to transition from a given page state to another page state In the specific example embodiment where a given page state coincides with a single page, for instance, each page state corresponding to one page of the digitally constructed, ordered sequence of pages paginated to comprise, in one embodiment, an e-book. In some implementations, the page transitioning logic enables single page transitions, chapter transitions, or cluster transitions (multiple pages at one time).

According to some embodiments, the e-reading device 110 includes display sensor logic 135 to detect and interpret user input or user input commands made through interaction with the touch sensors 138. By way of example, display sensor logic 135 can detect a user making contact with the touch-sensing region of the display screen 116, otherwise known as a touch event. More specifically, display sensor logic 135 can detect a touch events also referred to herein as a tap, an initial tap held in contact with display screen 116 for longer than some pre-defined threshold duration of time (otherwise known as a “long press” or a “long touch”), multiple taps performed either sequentially or generally simultaneously, swiping gesture actions made through user interaction with the touch sensing region of the display screen 116, or any combination of these gesture actions. Although referred to herein as a “touch” or a tap, it should be appreciated that in some design implementations, sufficient proximity to the screen surface, even without actual physical contact, may register a “contact” or a “touch event”. Furthermore, display sensor logic 135 can interpret such interactions in a variety of ways. For example, each such interaction may be interpreted as a particular type of user input associated with a respective input command, execution of which may trigger a change in state of display 116.

In one implementation, display sensor logic 135 implements operations to monitor for the user contacting or superimposing upon, using a finger, thumb or stylus, a surface of display 116 coinciding with a placement of one or more touch sensor components 138, that is, a touch event, and also detects and correlates a particular gesture action (e.g., pinching, swiping, tapping, etc.) as a particular type of input command. Display sensor logic 135 may also sense directionality of a user gesture action so as to distinguish between, for example, leftward, rightward, upward, downward and diagonal swipes along a surface portion of display screen 116 for the purpose of associating respective user input commands therewith.

E-library view (or interface) logic 120 provides an interface, displayable via display screen 116 of computing device 110, showing titles in a user's e-library collection of e-books, or from a user's home page in relation to an online content store 122 hosting e-books for commercial sale and downloading therefrom. The e-library collection of e-books may be hosted via a remotely located computer server device associate with user account e-library 124, or at a locally resident within a memory at computing device 110. The e-library view logic 120 can display iconic or other graphic representations of individual e-books in the user's e-library collection. For example, the e-library view logic 120 can use the metadata associated with the records of the e-books in the user's e-library account 124 to display lists, folders, or other virtual structures that include graphic representations and/or other identifiers of e-books in the user's collection. The metadata set can include, for example, information such as the graphic representation of the e-hook, such as including artwork- or image-based representation of a counterpart physical paper book cover, as well as summary information, author information, title, short synapse or book review, publication date and language of the e-book, and book or volume series information. The t sees collection can include e-books that the user has on the particular device 110 (e.g., locally stored e-books), as well as e-books that are not locally stored, but rather are stored or archived at a remote computer server and associated with the user account e-library 124.

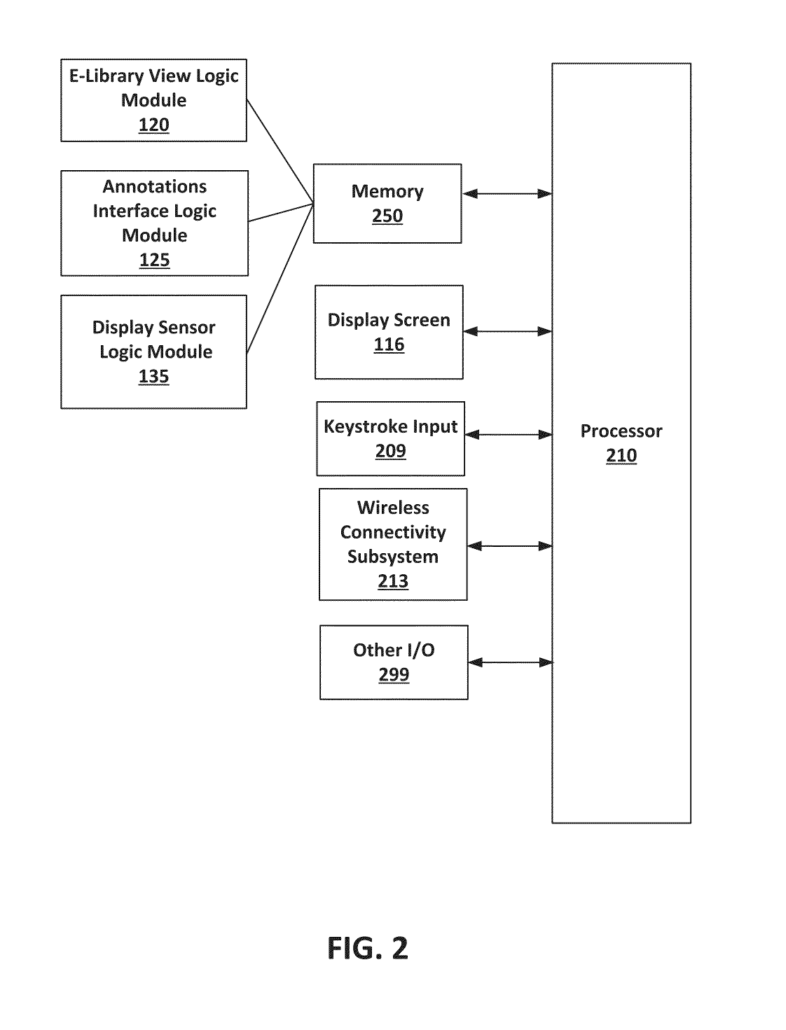

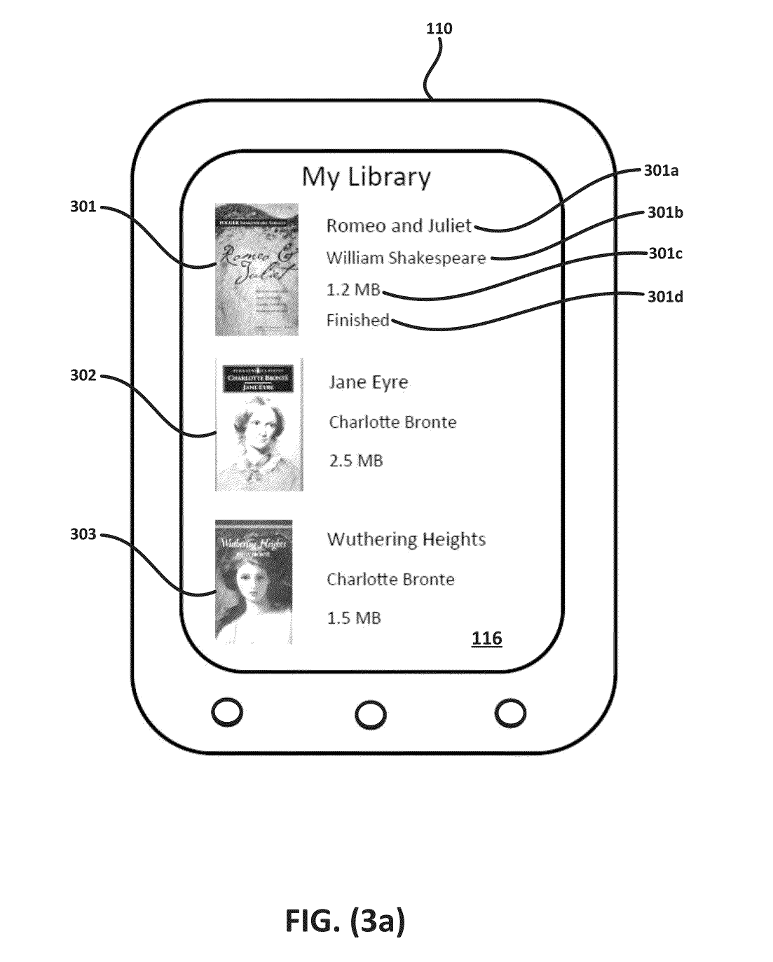

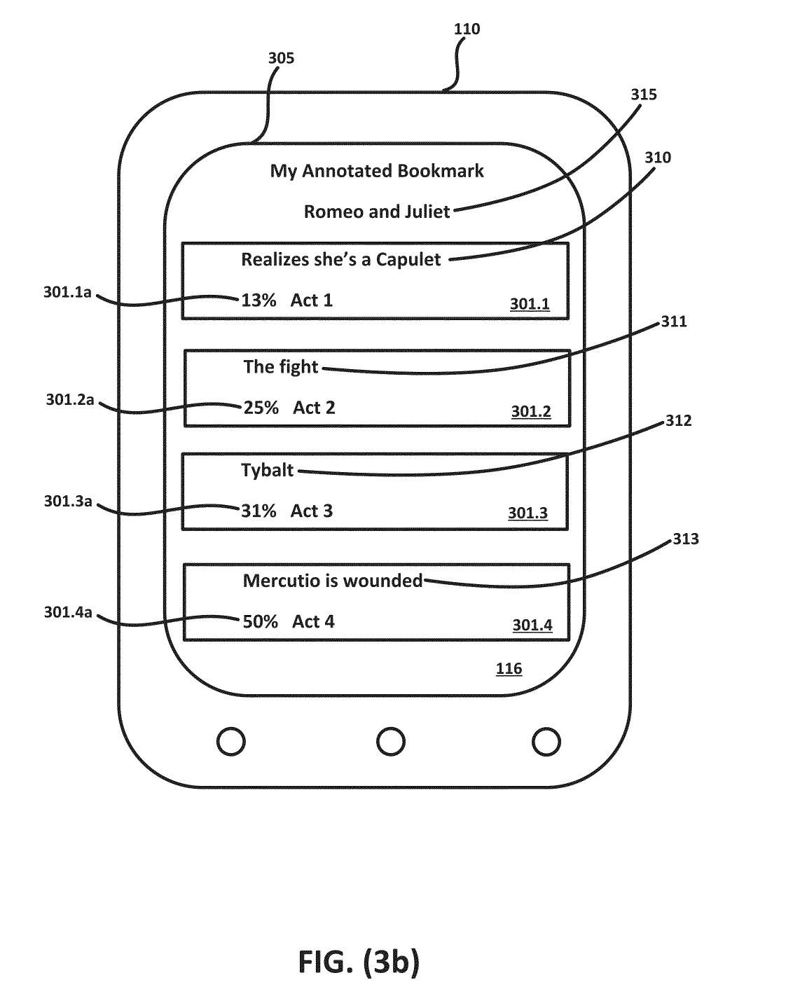

Annotations interface logic module 125 provides an annotations and boo marking scheme in conjunction with the interface rendered via e-library view logic 120, providing an annotations interface page(s) to be deployed upon launch in lieu of a table of contents or a first page of an e-book for reading. Launch of the e-book tier reading, in one embodiment, is triggered by a user enacting a touch event upon a graphical icon representing a specific e-book from an e-library collection, as will be described further in regard to FIGS. 2, 3a and 3b.

E-library view logic module 120 and annotations interface logic module 125 can be implemented as software modules comprising instructions stored in a memory of mobile computing device 110, as described in further detail below with regard to FIG. 2.

In one or more embodiments of e-library view logic module 120, display sensor logic 135 and annotations interface logic module 125 described herein may be implemented using programmatic modules or components. A programmatic module or component may include a. program, a subroutine, a portion of a program, or a software or a hardware component capable of performing one or more stated tasks or functions in conjunction with one or more processors. As used herein, a module or component can exist on a hardware component independently of other modules or components. Alternatively, a module or component can be a shared element or process of other modules, programs and hardware components.

Furthermore, the one or more embodiments of e-library view logic module 120, display sensor logic 135 and annotations interface logic module 125 described herein may be implemented through instructions that are executable by one or more processors. These instructions may be stored on a computer-readable non-transitory medium. In particular, the numerous computing and communication devices shown with embodiments of the invention include processor(s) and various forms of computer memory, including volatile and non-volatile forms, storing data and instructions. Examples of computer-readable mediums include permanent memory storage devices, such as hard drives on personal computers or servers. Other examples of computer storage mediums include portable storage units, flash or solid-state memory (such as included on many cell phones and consumer electronic devices) and magnetic memory. Computers, terminals, network enabled devices (e.g., mobile devices such as cell phones and wearable computers) are all examples of machines and devices that utilize processors, memory, and instructions stored on computer-readable mediums. Additionally, embodiments may be implemented in the form of computer-programs, or a computer usable storage medium capable of storing such a program.

FIG. 2 illustrates a schematic architecture of a computing device for configuring and launching an e-book reading interface, according to an embodiment.

E-reading device 110 further includes processor 210, a memory 250 storing instructions and logic pertaining at least to display sensor logic 135, e-library view logic module 120 and annotations interface logic 125.

Processor 210 can implement functionality using the logic and instructions stored in memory 250. Additionally, in some implementations, processor 210 communicates with the network service 121 (see FIG. 1). More specifically, the e-reading device 110 can access the network service 121 to receive various kinds of resources (e.g., digital content items such as e-books, configuration files, account information), as well as to provide information (e.g., user account information, service requests etc.). For example, e-reading device 110 can receive application resources, such as e-books or media tiles, that the user elects to purchase or otherwise download via the network service 121. The application resources that are downloaded onto the e-reading device 110 can be stored in memory 250.

In some implementations, display 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components 138 may be integrated with display 116. In other embodiments, the touch sensor components 138 may be provided (e.g., as a layer) above or below display 116 such that individual touch sensor components 138 track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can receive input from various sources, including touch sensor components 138, display 116, keystroke input 208 such as from a virtual or rendered keyboard, and other input mechanisms 299 (e.g., buttons, mouse, microphone, etc.). With reference to examples described herein, processor 210 can respond to input detected at the touch sensor components 138. In some embodiments, processor 210 responds to inputs from the touch sensor components 138 in order to facilitate or enhance e-book activities such as generating e-book content on display 116, performing page transitions of the displayed e-book content, powering off the device 110 and/or display 116, activating a screen saver, launching or closing an application, and/or otherwise altering a state of display 116.

In sonic embodiments, memory 250 may store display sensor logic 135 that monitors for user interactions detected through the touch sensor components 138, and further processes the user interactions as a particular input or type of input. In an alternative embodiment, display sensor logic module 135 may be integrated with the touch sensor components 138. For example, the touch sensor components 138 can be provided as a modular component that includes integrated circuits or other hardware logic, and such resources can provide sonic or all of display sensor logic 135. In variations, some or all of display sensor logic 135 may be implemented with processor 210 (which utilizes instructions stored in memory 250), or with an alternative processing resource.

E-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which computing device 110 is intended to operate, such as in accordance with Wi-Fi, Bluetooth, Near Field Communication (NFC) communication protocols, and the like.

E-library view logic module 120 can be implemented as a software module, comprising instructions stored in memory 250, on mobile computing device 110. In one implementation, the local memory 250 can include records for each e-book in the user's e-library account 124, each record include metadata of the e-books therein. The user may have the content portion of select e-books archived remotely at a computer server cloud system, so as not to reside in the local memory 250, but be provided by the network service 121 upon request or as needed. By way of example, the e-library view logic module 120 can display the e-books of a user's collection in the form of a virtual bookshelf or bookcase feature showing graphical icons representing the e-books. In such an implementation, thee-boobs are displayed as icons that include imagery, title information, etc. In a variation, the e-library view module 120 can display representations of e-books in the user's collection as icons, or as icons with associated text. Still further, folders can be used to provide a panel view of the graphic representations e.g., icons and/or text) of thee-books in the user's e-library collection 124, corresponding to a side view of a bookshelf showing book spines with titles printed thereon for identifying individual books.

Annotations interface logic 125 can be implemented as a software module comprising instructions stored in memory 250 of computing device 110. Annotations interface logic module 125 provides a provides an annotations and bookmarking interface scheme in conjunction with e-library view logic 120, configuring an annotations interface page(s), which can be deployed upon a subsequent launch of an e-book for reading. In embodiment, upon e-book launch for reading, the annotations interface page can be presented in lieu of a typical table of contents or a first substantive reading page. Launch of the e-book for reading may be triggered by a user enacting a touch event upon a graphical icon representing a specific e-book from e-library collection 124 as displayed on display screen 116 via e-library view logic 120.

FIGS. 3a and 3b illustrate example embodiments for operation in configuring and launching an e-book reading interface.

FIG. 3a illustrates a view of a user's e-library collection (or a part thereof) of e-books as rendered in conjunction with e-library view logic 120, and as represented via graphical icons 301, 302, 303 within display screen 116 of computing device 110. The graphical icon depiction may be accompanied by any or all of e-book title 301a, author name 301b, a memory size of the e-book 301c and reading status summary 301d for any or all of the e-books depicted within display screen 116.

In prelude to the depiction of FIG. 3b, the user proceeds to enact a touchscreen display touch event, such as a tap or a swipe, upon a selected graphical icon 301 in the embodiment described above, as rendered in conjunction with user account e-library 124 and e-library view logic 120.

As depicted in FIG. 3b, annotations indicia 301.1 through 301.4 may be rendered upon touch screen display 116 of computing device 110 within annotations interface page 305. Annotations indicia 301.1 through 301.4 may show the actual user annotation entries 310 through 313 respectively, providing a user-personalization aspect to annotations interface page 305. Annotations indicia 301,1 through 301.4 may further depict a reading progress indicator showing a relative position within the e-book with which the annotation is associated or was made by the user. In one embodiment, the reading progress indicator comprises a percentage completion metric 301.1a through 301.4a, but it is contemplated that other forms of reading progress indications, including page numbers, may be applied.

In the depiction of FIG. 3b, annotation entry 311, in an example embodiment, may comprise a later-added or further-added annotation onto a content portion of the e-book which is in an intermediate location between content portions of the e-book associated with annotation entries 310 and 312. Thus once added to annotations interface 305, annotation entry will be ordered in-between annotation entries 310 and 312.

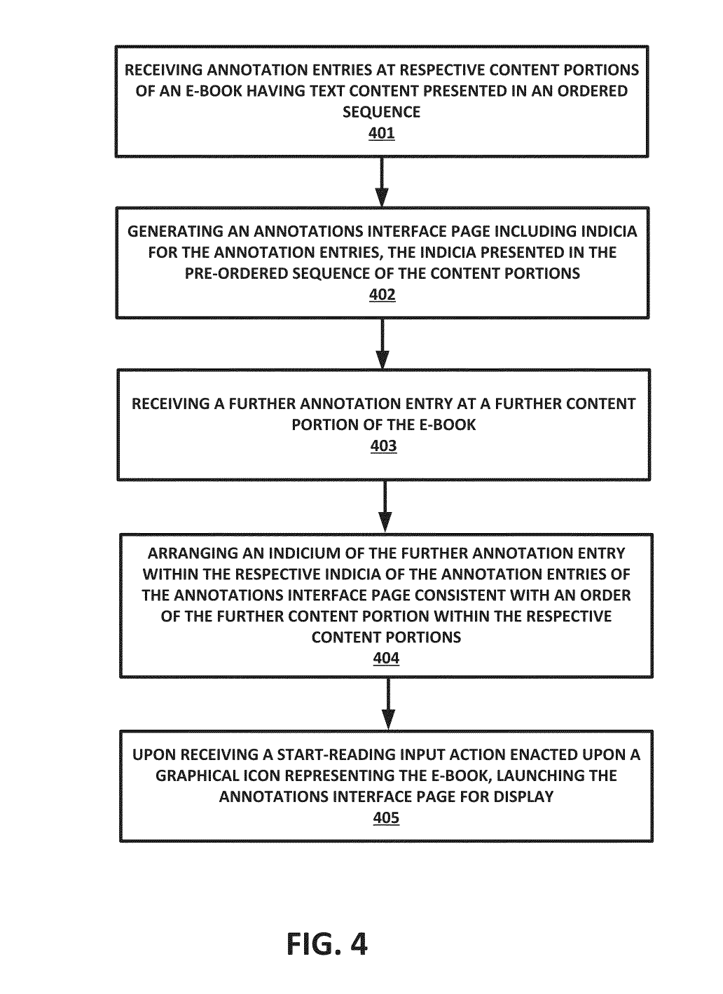

Next with reference to FIG. 4, illustrated is a method for operation in configuring and launching an e-book reading interface on a computer device having a touchscreen display, according to an embodiment. In describing the example of FIG. 4, reference will be made to components such as described with regard to FIGS. 1 through 3 for purposes of illustrating components for performing a step or sub-step as described.

At step 401, receiving annotation entries 310, 301.2, 301.4 at respective content portions of an e-book having text content presented in an ordered sequence.

At step 402, generating an annotations interface page 305 including indicia 301.1, 301.3 301.4 for the annotation entries, the indicia presented in the pre-ordered sequence of the content portions.

At step 403, receiving a further annotation entry 311 at a further content portion of the e-book.

At step 404, arranging an indicium 301.2 of the further annotation entry 311 within the respective indicia 310, 312, 313 of the annotation entries of the annotations interface page 305 consistent with an order of the further content portion within the respective content portions.

At step 405, upon receiving a start-reading input action enacted upon a graphical icon 301 representing the e-book, launching the annotations interface page 305 showing the e-book title 315 for display at display screen 116 of computing device 110.

Although illustrative embodiments have been described in detail herein with reference to the accompanying drawings, variations to specific embodiments and details are contemplated and encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method executed in a processor of a computing device, the computing device including a memory storing instructions and a display screen having touch functionality, the method comprising:
receiving a plurality of annotation entries at respective content portions of an e-book having text content presented in a pre-ordered sequence of the content portions;
generating an annotations interface page including respective indicia of the annotation entries, the respective indicia presented in the pre-ordered sequence of the content portions;
receiving a further annotation entry at a further content portion of the e-book;
arranging an indicium of the further annotation entry within the respective indicia of the annotation entries of the annotations interface page consistent with an order of the further content portion within the respective content portions; and
upon receiving a start-reading input action enacted upon a graphical icon representing the e-book launching the annotations interface page for display at the display screen.

2. The method of claim 1 wherein the graphical icon representing the e-book is accessed within an electronic library (e-library) including a collection of e-books.

3. The method of claim 2 wherein the e-library includes metadata of respective e-books of the collection.

4. The method of claim 3 wherein the graphical icon comprises cover artwork and text sourced from the metadata and correspondingly rendered on an as-published physical book counterpart of the e-book.

5. The method of claim 1 wherein the e-library is hosted at one of: a remotely located computer server device and the memory of the computing device.

6. The method of claim 1 wherein the start-reading input received at the display screen comprises a touch event enacted upon the graphical icon.

7. The method of claim 1 further comprising navigating to the further content portion of the e-book by enacting a touch event upon the indicium of the further annotation.

8. The method of claim 1 wherein the representative indicia of the annotation entries include the respective annotation entries.

9. The method of claim 1 wherein the representative indicia of the annotation entries include a reading progress indicator associated with the respective content portions.

10. The method of claim 8 wherein the reading progress indicator consists of one of: a percentage and a page number relative to the content of the e-book.

11. A computer-readable medium that stores instructions for a computing device, the computing device including a processor, a memory and a display screen having touch functionality, the instructions being executable by the processor to cause the computing device to perform operations that include:
receiving a plurality of annotation entries at respective content portions of an e-book having text content presented in a pre-ordered sequence of the content portions;
generating an annotations interface page including respective indicia of the annotation entries, the respective indicia presented in the pre-ordered sequence of the content portions;
receiving a further annotation entry at a further content portion of the e-book;
arranging an indicium of the further annotation entry within the respective indicia of the annotation entries of the annotations interface page consistent with an order of the further content portion within the respective content portions; and
upon receiving a start-reading input action enacted upon a graphical icon representing the e-book, launching the annotations interface page for display at the display screen.

12. A computing device comprising:
a memory that stores a set of instructions;
a display screen having touch functionality;
a processor that access the instructions in memory, the processor further configured to:
receive a plurality of annotation entries at respective content portions of an e-book having text content presented in a pre-ordered sequence of the content portions;
generate an annotations interface par including respective indicia of the annotation entries, the respective indicia presented in the pre-ordered sequence of the content portions;
receive a further annotation entry at a further content portion of the e-book;
arrange an indicium of the further annotation entry within the respective indicia of the annotation entries of the annotations interface page consistent with an order of the further content portion within the respective content portions; and
upon receiving a start-reading input action enacted upon a graphical icon representing the e-book, launching the annotations interface page for display at the display screen.

13. The computing device of claim 12 wherein the graphical icon representing the e-book is accessed within an electronic library (e-library) including a collection of e-books.

14. The computing device of claim 13 wherein the e-library includes metadata of respective e-books of the collection.

15. The computing device of claim 14 wherein the graphical icon comprises cover artwork and text sourced from the metadata and correspondingly rendered on an as-published physical book counterpart of the e-book.

16. The computing device of claim 12 wherein the e-library is hosted at one of: a remotely located computer server device and the memory of the computing device.

17. The computing device of claim 12 wherein the start-reading input received at the display screen comprises a touch event enacted upon the graphical icon.

18. The computing device of claim 12 further comprising navigating to the further content portion of the e-book by enacting a touch event upon the indicium of the further annotation.

19. The computing device of claim 12 wherein the representative indicia of the annotation entries include the respective annotation entries.

20. The computing device of claim 12 wherein the representative indicia of the annotation entries include a reading progress indicator associated with the respective content portions.

21. The computing device of claim 20 wherein the reading progress indicator consists of one of: a percentage and a page number relative to the content of the e-book.
